(19) United States
(12) Patent Application Publication
(10) Pub. No.: US 2011/0190173 A1
(43) Pub. Date: Aug. 4, 2011

(54) ACIDIC TREATMENT FLUIDS AND ASSOCIATED METHODS

(76) Inventors: Juanita M. Cassidy, Duncan, OK (US); Jim L. Lane, Duncan, OK (US); Chad E. Kiser, Comanche, OK (US)

(21) Appl. No.: 13/086,797

(22) Filed: Apr. 14, 2011

Related U.S. Application Data
(62) Division of application No. 11/448,945, filed on Jun. 7, 2006, now abandoned.

(51) Int. Cl. C09K 8/52; C09K 8/66; C09K 8/54

(52) U.S. Cl. 507/241; 507/274; 507/267; 507/266; 507/272

(57) ABSTRACT

Treatment fluids that comprise a phosphorus component useful for inhibiting metal corrosion in acidic environments and associated methods of use are provided. An example of a method of using such treatment fluids may comprise providing a treatment fluid that comprises: an aqueous base fluid, a weak acid or salt thereof, and a phosphorus component, and introducing the treatment fluid into a subterranean formation.

### CROSS-REFERENCE TO RELATED APPLICATIONS

This application is a divisional application of U.S. application Ser. No. 11/448,945, filed on Jun. 7, 2006, the entire disclosure of which is incorporated herein by reference.

### BACKGROUND

The present invention relates to methods and compositions for treating subterranean formations. More particularly, the present invention relates to treatment fluids that comprise a phosphorus component useful, inter alia, for inhibiting metal corrosion in acidic environments, and associated methods of use.

Acidic fluids may be present in a multitude of operations in the oil and chemical industry. In these operations, metal surfaces in piping, tubing, heat exchangers, and reactors may be exposed to acidic fluids. Acidic fluids are often used as a treating fluid in wells penetrating subterranean formations. Such acidic treatment fluids may be used in, for example, clean-up operations or stimulation operations for oil and gas wells. Acidic stimulation operations may use these treatment fluids in hydraulic fracturing and matrix acidizing treatments. As used herein, the term “treatment fluid” refers to any fluid that may be used in an application in conjunction with a desired function and/or for a desired purpose. The term “treatment” does not imply any particular action by the fluid or any component thereof.

Acidic treatment fluids may include a variety of acids such as, for example, hydrochloric acid, formic acid, hydrofluoric acid, and the like. While acidic treatment fluids may be useful for a variety of downhole operations, acidic treatment fluids can be problematic in that they can cause corrosion to downhole production tubing, downhole tools, and other surfaces in a subterranean formation. As used herein, the term “corrosion” refers to any reaction between a material and its environment that causes some deterioration of the material or its properties. Examples of common types of corrosion include, but are not limited to, the rusting of metal, the dissolution of a metal in an acidic solution, and patina development on the surface of a metal. As used herein, the term “inhibit” refers to lessening the tendency of a phenomenon to occur and/or the degree to which that phenomenon occurs. The term “inhibit” does not imply any particular degree or amount of inhibition.

To combat this potential corrosion problem, an assortment of corrosion inhibitors have been used to reduce or prevent corrosion to downhole metals and metal alloys with varying levels of success. A difficulty encountered with the use of some corrosion inhibitors is the limited temperature range over which they may function effectively. For instance, certain conventional antimony-based inhibitor formulations have been limited to temperatures above 270° F. and do not appear to function effectively below this temperature.

Another drawback of some conventional corrosion inhibitors is that certain corrosion inhibitors' components may not be compatible with the environmental standards in some regions of the world. For example, quaternary ammonium compounds and “Mannich” condensation compounds have been used as corrosion inhibitors. However, these compounds generally are not acceptable under stricter environmental regulations, such as those applicable in the North Sea region or other regions. Consequently, operators in some regions may be forced to suffer increased corrosion problems, resort to using corrosion inhibitor formulations that may be less effective, or forego the use of certain acidic treatment fluids entirely.

### SUMMARY

The present invention relates to methods and compositions for treating subterranean formations. More particularly, the present invention relates to treatment fluids that comprise a phosphorus component useful, inter alia, for inhibiting metal corrosion in acidic environments, and associated methods of use.

In one embodiment, the present invention provides a method that comprises: providing a treatment fluid that comprises an aqueous base fluid, a weak acid or salt thereof, and a phosphorus component, and introducing the treatment fluid into a subterranean formation.

In another embodiment, the present invention provides a method that comprises: providing a treatment fluid that comprises an aqueous base fluid, a weak acid or salt thereof, and a phosphorus component, introducing the treatment fluid into at least a portion of a subterranean formation, contacting a surface in the subterranean formation with the treatment fluid, and allowing the treatment fluid to interact with the surface in the subterranean formation so as to inhibit corrosion of the surface.

In another embodiment, the present invention provides a method that comprises: providing a treatment fluid that comprises an aqueous base fluid, a weak acid or salt thereof, and a phosphorus component, providing a surface wherein an undesirable substance resides on the surface, and allowing the treatment fluid to contact the surface so that at least a portion of the undesirable substance is removed.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to methods and compositions for treating subterranean formations. More particularly, the present invention relates to treatment fluids that comprise a phosphorus component useful, inter alia, for inhibiting metal corrosion in acidic environments, and associated methods of use.

One of the advantages of the treatment fluids of the present invention is that they may be more effective than corrosion inhibitors heretofore used and/or may possess desirable environmental properties for use in downhole environments, especially those that may be subject to more stringent environmental regulations. Another advantageous feature of the present invention is that the phosphorus components of the present invention may not require a high pH range. For example, in certain embodiments of the present invention, the treatment fluid may have a pH of less than about 7.

The treatment fluids of the present invention generally comprise an aqueous base fluid, a weak acid, and a phosphorus component. The term “weak acid” is defined herein to include any acidic compound with a pH greater than 1 that does not dissociate completely in an aqueous fluid. The term “phosphorus component” is defined herein to include anything containing a phosphorus atom or ion or combination thereof.

The aqueous base fluids used in the treatment fluids of the present invention may comprise fresh water, saltwater (e.g., water containing one or more salts dissolved therein), brine, seawater, or combinations thereof. Generally, the water may be from any source, provided that it does not contain components that might adversely affect the stability and/or performance of the treatment fluids of the present invention. One of ordinary skill in the art, with the benefit of this disclosure, will recognize what components might adversely affect the stability and/or performance of the treatment fluids of the present invention.

A variety of weak acids can be used in conjunction with the methods and compositions of the present invention. Examples of suitable weak acids include, but are not limited to, formic acid, acetic acid, citric acid, glycolic acid, hydroxyacetic acid, lactic acid, hydrofluoric acid, 3-hydroxypropionic acid, carbonic acid, and ethylenediaminetetraacetic acid. An example of a suitable commercially available weak acid is “Volcanic Acid II™” available from Halliburton Energy Services, Inc. Alternatively or in combination with one or more weak acids, the treatment fluids of the present invention may comprise a salt of a weak acid. A “salt” of an acid, as that term is used herein, refers to any compound that shares the same base formula as the referenced acid, but one of the hydrogen cations thereon is replaced by a different cation (e.g., an antimony, bismuth, potassium, sodium, calcium, magnesium, cesium, or zinc cation). Examples of suitable salts of weak acids include, but are not limited to, sodium acetate, sodium formate, sodium citrate, sodium hydroxyacetate, sodium lactate, sodium fluoride, sodium propionate, sodium carbonate, calcium acetate, calcium formate, calcium citrate, calcium hydroxyacetate, calcium lactate, calcium fluoride, calcium propionate, calcium carbonate, cesium acetate, cesium formate, cesium citrate, cesium hydroxyacetate, cesium lactate, cesium fluoride, cesium propionate, cesium carbonate, potassium acetate, potassium formate, potassium citrate, potassium hydroxyacetate, potassium lactate, potassium fluoride, potassium propionate, potassium carbonate, magnesium acetate, magnesium formate, magnesium citrate, magnesium hydroxyacetate, magnesium lactate, magnesium fluoride, magnesium propionate, magnesium carbonate, zinc acetate, zinc formate, zinc citrate, zinc hydroxyacetate, zinc lactate, zinc fluoride, zinc propionate, zinc carbonate, antimony acetate, antimony formate, antimony citrate, antimony hydroxyacetate, antimony lactate, antimony fluoride, antimony propionate, antimony carbonate, bismuth acetate, and bismuth formate, bismuth citrate, bismuth hydroxyacetate, bismuth lactate, bismuth fluoride, bismuth carbonate, and bismuth propionate. The treatment fluids of the present invention may comprise any combination of weak acids and/or salts thereof. The weak acid (or salts thereof) may be present in an amount in the range of from about 1% by weight of the treatment fluid to about 30% by weight of the treatment fluid. In certain embodiments, the weak acid (or salts thereof) may be present in an amount in the range of from about 5% by weight of the treatment fluid to about 10% by weight of the treatment fluid. The amount of the weak acid(s) (or salts thereof) included in a particular treatment fluid of the present invention may depend upon the particular acid and/or salt used, as well as other components of the treatment fluid, and/or other factors that will be recognized by one of ordinary skill in the art with the benefit of this disclosure.

The phosphorus component may comprise a phosphorus atom or ion, and a cation (e.g., an antimony, bismuth, potassium, sodium, calcium, magnesium, cesium, or zinc cation). Examples of suitable phosphorus components include, but are not limited to, antimony phosphate, bismuth phosphate, potassium phosphate, sodium phosphate, calcium phosphate, magnesium phosphate, cesium phosphate, zinc phosphate, antimony pyrophosphate, bismuth pyrophosphate, potassium pyrophosphate, sodium pyrophosphate, calcium pyrophosphate, magnesium pyrophosphate, cesium pyrophosphate, zinc pyrophosphate, antimony hypophosphite, bismuth hypophosphite, potassium hypophosphite, sodium hypophosphite, calcium hypophosphite, magnesium hypophosphite, cesium hypophosphite, zinc hypophosphite, antimony polyphosphate, bismuth polyphosphate, potassium polyphosphate, sodium polyphosphate, calcium polyphosphate, magnesium polyphosphate, cesium polyphosphate, zinc polyphosphate, phosphoric acid, antimony metaphosphate, bismuth metaphosphate, potassium metaphosphate, sodium metaphosphate, calcium metaphosphate, magnesium metaphosphate, cesium metaphosphate, and zinc metaphosphate. The phosphorus component may be present in an amount in the range of from about 0.5% to about 7% by weight of treatment fluid. In certain embodiments, the phosphorus component may be present in an amount in the range of from about 0.6% to about 5% by weight of treatment fluid.

In certain embodiments, the treatment fluid of the present invention may optionally comprise a surfactant. A surfactant may, among other things, aid in the dispersibility of the phosphorus component and/or may assist in the coating of the phosphorus component on at least a portion of the surfaces to be treated. In certain embodiments, a surfactant may aid in achieving a more uniform coating (complete or partial) on the surface. Where included, the surfactant may be cationic or nonionic (i.e., not anionic). Examples of surfactants suitable for use in the present invention include, but are not limited to, alkoxylated fatty acids, alkoxylated alcohols, such as lauryl alcohol ethoxylate or ethoxylated nonyl phenol; and ethoxylated alkyl amines, such as cocoalkylamine ethoxylate; alkylamidobetaines such as cocoamidopropyl betaine; trimethyltallowammonium chloride, trimethylcocoammonium chloride, and ethoxylated amides. The term “derivative” is defined herein to include any compound that is made from one of the listed compounds, for example, by replacing one atom in the listed compound with another atom or group of atoms, rearranging two or more atoms in the listed compound, ionizing the listed compounds, or creating a salt of the listed compound. The use of a surfactant as well as the type and amount of the surfactant included in a particular treatment fluid of the present invention may depend upon the temperatures of the treatment fluid or subterranean formation, other components present in the treatment fluid, and/or other factors that will be recognized by one of ordinary skill in the art with the benefit of this disclosure.

The treatment fluids of the present invention optionally may include one or more of a variety of well-known additives, such as gel stabilizers, salts, fluid loss control additives, scale inhibitors, organic corrosion inhibitors, catalysts, clay stabilizers, biocides, bactericides, friction reducers, gases, foaming agents, iron control agents, solubilizers, pH adjusting agents (e.g., buffers), and the like. In certain embodiments, the treatment fluids may include salts (e.g. MgCl₂) that may, inter alia, prevent the precipitation of calcium when such treatment fluids are used to acidize formations containing calcium carbonate. Those of ordinary skill in the art, with the benefit of this disclosure, will be able to determine the appropriate additives for a particular application.

Generally, some of the methods of the present invention involve inhibiting the corrosion of a portion of a surface in a subterranean formation. In one embodiment, the present invention provides a method of treating a portion of a subterranean formation comprising: providing a treatment fluid comprising an aqueous base fluid, a weak acid or salt thereof, and a phosphorus component; introducing the treatment fluid into at least a portion of a subterranean formation; contacting a surface in the subterranean formation with the treatment fluid; and allowing the treatment fluid to interact with the surface so as to inhibit corrosion of the surface. In certain embodiments, the surface may be a metallic portion of the subterranean formation susceptible to corrosion. In certain embodiments, the surface may be a metal surface, for example, on a tool within the subterranean formation. The surfaces treated in certain embodiments of the present invention may include any surface susceptible to corrosion in an acidic environment including, but not limited to, ferrous metals, low alloy metals (e.g., N-80 Grade), stainless steel (e.g., 13 Cr), copper alloys, brass, nickel alloys, and duplex stainless steel alloys. Such surfaces may include downhole piping, downhole tools, as well as any other surface present in a subterranean formation. In certain of these embodiments, the treatment fluid may be sprayed onto the surface. In certain other embodiments, the surface to be treated may be submerged in a bath of treatment fluid.

In certain other embodiments, the methods of the present invention may be used in near well bore clean-out operations, wherein a treatment fluid of the present invention may be circulated in the subterranean formation, thereby suspending or solubilizing particulates residing in the formation. The treatment fluid then may be recovered out of the formation, carrying the suspended or solubilized particulates with it. In certain embodiments, a treatment fluid of the present invention may be pumped into a well bore that penetrates a subterranean formation at a sufficient hydraulic pressure to create or enhance one or more cracks, or “fractures,” in the subterranean formation. “Enhancing” one or more fractures in a subterranean formation, as that term is used herein, is defined to include the extension or enlargement of one or more natural or previously created fractures in the subterranean formation.

In certain embodiments, the treatment fluids of the present invention may be used in subterranean or non-subterranean industrial cleaning operations. For example, in certain embodiments, a treatment fluid of the present invention may be used to remove damage from a surface in a subterranean formation or any other surface where those substances may be found. “Damage” may include boiler scale (e.g., magnetite or copper) or any other undesirable substance. In these embodiments, the weak acid in the treatment fluid of the present invention preferably may comprise citric acid, EDTA, or a salt thereof.

In other embodiments, the treatment fluid of the present invention may be used in fracture acidizing operations in subterranean formations. “Fracture acidizing” comprises injecting a treatment fluid comprising an acid into the formation at a pressure sufficient to create or enhance one or more fractures within the subterranean formation.

To facilitate a better understanding of the present invention, the following examples of certain aspects of some embodiments are given. In no way should the following examples be read to limit, or define, the entire scope of the invention.

### EXAMPLES

Coupon specimens made of N-80 Grade steel and 13 Cr stainless steel (˜4.4 in²) were cleaned, weighed, and immersed in 100 mL of the treatment fluids comprising water and an acid (indicated for each sample in Table 1), and certain treatment fluids also included a phosphorus component and/or an additional inhibitor (MSA-III™ inhibitor 2.0% (v/v) available from Halliburton Energy Services, Inc., Duncan, Okla.). The coupon specimens immersed in treatment fluid were pressurized to 1000 psi and then heated to the test temperature indicated in Table 1 below for the contact time indicated. After the contact time elapsed, any residues were cleaned from the specimens and the coupons were weighed again to determine the amount of corrosion loss by subtracting the final weight of the specimen from its initial weight before the test. The results are reported in Table 1 below. The data in Table 1 demonstrates the efficacy of the treatment fluid compositions as compared to the same composition used with no phosphorus component.

TABLE 1
Pressurized Corrosion Tests

| Temperature | Time | | Acid | Phosphorus | Additional | Corrosion Loss |
|---|---|---|---|---|---|---|
| (° F.) | (hr) | Coupon | (wt %) | Component | Inhibitor | (lb/ft²) |
| 200 | 6 | N80 | 10% Formic Acid | | blank | 0.264 |
| 200 | 6 | N80 | 10% Formic Acid | Sodium | | 0.012 |
| | | | | pyrophosphate, | | |
| | | | | 0.69 g | | |
| 350 | 6 | N80 | 13% Glycolic | | MSA-III ^{™} | 0.023 |
| | | | Acid & 1% HF | | inhibitor | |
| | | | | | 2.0% | |
| 350 | 6 | N80 | 13% Glycolic | Sodium | | 0.010 |
| | | | Acid & 1% HF | pyrophosphate, | | |
| | | | | 1.38 g | | |
| 350 | 6 | N80 | 13% Glycolic | Sodium | | 0.034 |
| | | | Acid & 1% HF | pyrophosphate, | | |
| | | | | 0.69 g | | |
| 350 | 6 | N80 | Volcanic Acid II | Sodium | MSA III | 0.012 |
| | | | | metaphosphate, | 2.0% | |
| | | | | 0.69 g | | |
| 350 | 6 | N80 | 10% Acetic Acid | | blank | 0.277 |
| 350 | 6 | N80 | 10% Acetic Acid | Sodium | | 0.002 |
| | | | | pyrophosphate, | | |
| | | | | 1.38 g | | |
| 350 | 6 | N80 | 10% Acetic Acid | Sodium | | 0.005 |
| | | | | polyphosphate, | | |
| | | | | 2.12 g | | |
| 350 | 6 | N80 | 10% Acetic Acid | Phosphoric | | 0.009 |
| | | | | acid, 0.65 mL | | |
| 350 | 6 | N80 | 10% Acetic Acid | Sodium | | 0.008 |
| | | | | hypophosphite, | | |
| | | | | 1.10 g | | |
| 350 | 6 | N80 | 10% Formic Acid | | blank | 0.297 |
| 350 | 6 | N80 | 10% Formic Acid | Sodium | | 0.039 |
| | | | | pyrophosphate, | | |
| | | | | 2.76 g | | |
| 350 | 6 | N80 | 10% Formic Acid | Sodium | | 0.051 |
| | | | | hypophosphite, | | |
| | | | | 2.20 g | | |
| 350 | 6 | N80 | 10% Formic Acid | Sodium | | 0.021 |
| | | | | polyphosphate, | | |
| | | | | 4.24 g | | |
| 350 | 6 | N80 | 10% Formic Acid | Phosphoric | | 0.302 |
| | | | | acid, 1.30 mL | | |
| 350 | 6 | N80 | 10% Formic Acid | Sodium | | 0.018 |
| | | | | metaphosphate, | | |
| | | | | 4.24 g | | |
| 350 | 6 | 13Cr | 10% Formic Acid | | blank | 0.283 |
| 350 | 6 | 13Cr | 10% Formic Acid | Sodium | | 0.021 |
| | | | | pyrophosphate, | | |
| | | | | 1.38 g | | |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Also, the terms in the claims have their plain, ordinary meaning unless otherwise explicitly and clearly defined by the patentee.

What is claimed is:

1. A method comprising:
providing a treatment fluid that comprises:
an aqueous base fluid,
a weak acid or salt thereof, and
a phosphorus component comprising at least one phosphate; and
introducing the treatment fluid into a subterranean formation.

2. The method of claim 1 wherein the weak acid has a pH greater than 1.

3. The method of claim 1 wherein the weak acid comprises at least one acid selected from the group consisting of formic acid, acetic acid, citric acid, glycolic acid, lactic acid, hydrofluoric acid, 3-hydroxypropionic acid, carbonic acid, ethylenediaminetetraacetic acid, and any combination thereof.

4. The method of claim 1 wherein the phosphorus component comprises at least one phosphate selected from the group consisting of a pyrophosphate, a metaphosphate, a polyphosphate, and any combination thereof.

5. The method of claim 1 wherein phosphorus component comprises at least one phosphate selected from the group consisting of antimony pyrophosphate, bismuth pyrophosphate, potassium pyrophosphate, sodium pyrophosphate, calcium pyrophosphate, magnesium pyrophosphate, cesium pyrophosphate, zinc pyrophosphate, antimony polyphosphate, bismuth polyphosphate, potassium polyphosphate, sodium polyphosphate, calcium polyphosphate, magnesium polyphosphate, cesium polyphosphate, zinc polyphosphate, antimony metaphosphate, bismuth metaphosphate, potassium metaphosphate, sodium metaphosphate, calcium metaphosphate, magnesium metaphosphate, cesium metaphosphate, zinc metaphosphate, and any combination thereof.

6. The method of claim 1 wherein the treatment fluid has a pH less than 7.

7. The method of claim 1 further comprising allowing the treatment fluid to interact with a component of the subterranean formation so that the component is dissolved.

8. The method of claim 1 wherein introducing the treatment fluid into a subterranean formation comprises introducing the treatment fluid into a subterranean formation at or above a pressure sufficient to create or enhance one or more fractures within the subterranean formation.

9. A method comprising:
providing a treatment fluid that comprises:
an aqueous base fluid,
a weak acid or salt thereof, and
a phosphorus component comprising at least one phosphate;
introducing the treatment fluid into at least a portion of a subterranean formation;
contacting a surface in the subterranean formation with the treatment fluid; and
allowing the treatment fluid to interact with the surface in the subterranean formation so as to inhibit corrosion of the surface.

10. The method of claim 9 wherein the weak acid comprises at least one acid selected from the group consisting of formic acid, acetic acid, citric acid, glycolic acid, lactic acid, hydrofluoric acid, 3-hydroxypropionic acid, carbonic acid, ethylenediaminetetraacetic acid, and any combination thereof.

11. The method of claim 9 wherein the phosphorus component comprises at least one phosphate selected from the group consisting of a pyrophosphate, a metaphosphate, a polyphosphate, and any combination thereof.

12. The method of claim 9 wherein phosphorus component comprises at least one phosphate selected from the group consisting of antimony pyrophosphate, bismuth pyrophosphate, potassium pyrophosphate, sodium pyrophosphate, calcium pyrophosphate, magnesium pyrophosphate, cesium pyrophosphate, zinc pyrophosphate, antimony polyphosphate, bismuth polyphosphate, potassium polyphosphate, sodium polyphosphate, calcium polyphosphate, magnesium polyphosphate, cesium polyphosphate, zinc polyphosphate, antimony metaphosphate, bismuth metaphosphate, potassium metaphosphate, sodium metaphosphate, calcium metaphosphate, magnesium metaphosphate, cesium metaphosphate, zinc metaphosphate, and any combination thereof.

13. The method of claim 9 wherein the treatment fluid has a pH less than 7.

14. A method comprising:
providing a treatment fluid that comprises:
an aqueous base fluid,
a weak acid or salt thereof, and
a phosphorus component comprising at least one phosphate;
providing a surface wherein an undesirable substance resides on the surface; and
allowing the treatment fluid to contact the surface so that at least a portion of the undesirable substance is removed.

15. The method of claim 14 wherein the weak acid comprises at least one acid selected from the group consisting of formic acid, acetic acid, citric acid, glycolic acid, lactic acid, hydrofluoric acid, 3-hydroxypropionic acid, carbonic acid, ethylenediaminetetraacetic acid, and any combination thereof.

16. The method of claim 14 wherein the salt of the weak acid comprises at least one salt selected from the group consisting of sodium acetate, sodium formate, sodium citrate, sodium hydroxyacetate, sodium lactate, sodium fluoride, sodium propionate, sodium carbonate, calcium acetate, calcium formate, calcium citrate, calcium hydroxyacetate, calcium lactate, calcium fluoride, calcium propionate, calcium carbonate, cesium acetate, cesium formate, cesium citrate, cesium hydroxyacetate, cesium lactate, cesium fluoride, cesium propionate, cesium carbonate, potassium acetate, potassium formate, potassium citrate, potassium hydroxyacetate, potassium lactate, potassium fluoride, potassium propionate, potassium carbonate, magnesium acetate, magnesium formate, magnesium citrate, magnesium hydroxyacetate, magnesium lactate, magnesium fluoride, magnesium propionate, magnesium carbonate, zinc acetate, zinc formate, zinc citrate, zinc hydroxyacetate, zinc lactate, zinc fluoride, zinc propionate, zinc carbonate, antimony acetate, antimony formate, antimony citrate, antimony hydroxyacetate, antimony lactate, antimony fluoride, antimony propionate, antimony carbonate, bismuth acetate, and bismuth formate, bismuth citrate, bismuth hydroxyacetate, bismuth lactate, bismuth fluoride, bismuth carbonate, bismuth propionate, and any combination thereof.

17. The method of claim 14 wherein the phosphorus component comprises at least one phosphate selected from the group consisting of a pyrophosphate, a metaphosphate, a polyphosphate, and any combination thereof.

18. The method of claim 14 wherein the treatment fluid has a pH less than 7.

19. The method of claim 14 wherein allowing the treatment fluid to contact the surface comprises spraying the treatment fluid onto the surface.

20. The method of claim 14 wherein allowing the treatment fluid to contact the surface comprises submerging the surface in a bath of treatment fluid.
